(19) United States
(12) Patent Application Publication
(10) Pub. No.: US 2026/0079034 A1
(43) Pub. Date: Mar. 19, 2026

(54) METHOD FOR INSTALLING A CLAMP-ON ULTRASONIC MEASURING DEVICE, AND CLAMP-ON ULTRASONIC MEASURING DEVICE

(71) Applicant: Endress+Hauser Flowtec AG, Reinach (CH)

(72) Inventors: Sascha Grunwald, Steinen (DE); Achim Wiest, Weil am Rhein (DE)

(21) Appl. No.: 19/108,218

(22) PCT Filed: Aug. 8, 2023
(86) PCT No.: PCT/EP2023/071956

§ 371 Date: Mar. 3, 2025

(30) Foreign Application Priority Data
Sep. 2, 2022 (DE) 10 2022 122 329.9

(51) Int. Cl. G01F 1/66; G01F 15/18

(52) U.S. Cl. CPC G01F 1/662; G01F 15/18

(57) ABSTRACT

The disclosure relates to a method for installing a clamp-on ultrasonic measuring device on a pipeline in order to measure a media property of a medium flowing through the pipeline. The clamp-on ultrasonic measuring device has at least one clamp-on ultrasonic transducer. The pipeline has a wall with an outer surface, and the outer surface has a surface roughness with an average roughness value of at least 10 micrometers. In a first step, a sealing layer comprising a flowable compound is applied onto a wall section; in a second step, the sealing layer is cured; and in a third step during or after the curing step, one of the at least one clamp-on ultrasonic transducers is positioned and establishes an acoustic and mechanical contact with the separating device or the contacting element.

The invention relates to a method for installing a clamp-on ultrasonic measuring device on a pipeline in order to measure a media property of a medium flowing through the pipeline, and a clamp-on ultrasonic measuring device of this kind, the clamp-on ultrasonic measuring device having at least one clamp-on ultrasonic transducer.

Clamp-on ultrasonic measuring devices and devices for contacting clamp-on ultrasonic transducers on a pipeline are already known, as shown, for example, in DE102020111122B4. However, the contacting or acoustic coupling of clamp-on ultrasonic transducers is problematic in the case of pipelines with rough outer surfaces, such as pipelines containing fibers such as those made of asbestos cement, since long-term stable solutions are difficult to implement. For example, when grease is applied to such pipelines, the grease penetrates into the wall of the pipeline, so that the original coupling function is lost.

The object of the invention is therefore to propose a robust and long-term stable method for installing a clamp-on ultrasonic measuring device, and such a clamp-on ultrasonic measuring device.

The object is achieved by a method according to independent claim 1 and by a clamp-on ultrasonic measuring device according to independent claim 14.

In a method according to the invention for installing a clamp-on ultrasonic measuring device on a pipeline for measuring a media property of a medium flowing through the pipeline, the clamp-on ultrasonic measuring device has at least one clamp-on ultrasonic transducer,
wherein the pipeline has a wall with an outer surface,
wherein in a first method step a sealing layer comprising a flowable compound is applied onto a portion of the outer surface,
wherein in a second method step the sealing layer cures or is caused to cure,
wherein in a third method step, during or after curing, one of the at least one clamp-on ultrasonic transducers is positioned on the sealing layer.

In this way, a good acoustic, long-term stable contact between the clamp-on ultrasonic transducer and the pipeline can be achieved, while the clamp-on ultrasonic transducer can be easily removed.

In this context, curing means that a flowable compound becomes an elastic compound which, depending on the starting material, has an elasticity like rubber or like metal.

In one embodiment, the flowable compound is a plastic, self-curing compound and comprises at least one of the following materials: silicone, acrylic, PU, adhesives such as one-or two-component adhesives, putty, epoxy, varnish, paint, concrete, mortar.

In one embodiment, the flowable compound is brought into a flowable state by heating, cures by cooling, and comprises at least one of the following materials:
a solder, a glass, a hot-melt adhesive.

In one embodiment, the curing is controlled by UV light.

In one embodiment, the sealing layer is applied by additive manufacturing such as deposition welding, sintering such as laser sintering, or vulcanization.

In one embodiment, a separating device is installed between the clamp-on ultrasonic transducer and the compound.

By means of the separating device, the geometric shape of a plastic, self-curing compound can be influenced during or after curing, or the clamp-on ultrasonic transducer can be prevented from sticking to the compound. For example, in the case of materials that are liquid before curing, such as solder, surface roughness caused by curing can be rendered harmless.

In one embodiment, the separating device has a sheet or a film or a fabric and has a thickness of at most 10 millimeters, and in particular at most 3 millimeters and preferably at most 1 millimeter.

In one embodiment, the separating device is disc-shaped and in particular coordinated with the geometric dimensions of the clamp-on ultrasonic transducer.

In one embodiment, the separating device has, for example, at least one of the following materials:
a plastics material such as PET, PE, PVC, PS, PEI, PI, a metal such as aluminum, copper or stainless steel, metal alloys such as bronze or brass, a ceramic or a glass.

In one embodiment, the separating device has a coating on at least one side, which coating is self-adhesive, adhesion-enhancing or adhesion-reducing.

In one embodiment, the separating device has a volume or forms a volume in which the curable compound is arranged.

This makes it possible to ensure that the compound does not change its position before or during curing.

In one embodiment, the clamp-on ultrasonic transducer has the following:
a transducer element;
a coupling body with a first side facing away from the pipeline and a second side facing the pipeline,
wherein the transducer element is arranged on the first side, a base which is arranged on the second side of the coupling body, wherein the base is made of a plastic or resilient material such as silicone or acrylic,
wherein when positioning the clamp-on ultrasonic transducer, the base forms the acoustic and mechanical contact with the separating device or with the sealing layer.

A clamp-on ultrasonic flowmeter according to the invention configured according to a method according to one of the preceding claims comprising:
at least one clamp-on ultrasonic transducer with a transducer element, a coupling body with a first side facing away from the pipeline and a second side facing the pipeline,
wherein the transducer element is arranged on the first side, a base which is arranged on the second side of the coupling body, wherein when the clamp-on ultrasonic transducer is positioned, the base forms the acoustic and mechanical contact with the separating device or with the sealing layer;
an electronic measuring/operating circuit which is configured to operate the at least one clamp-on ultrasonic transducer, to evaluate measurement signals of the at least one clamp-on ultrasonic transducer, and to provide measured values of a measured variable.

The invention will be described in the following with reference to embodiments.

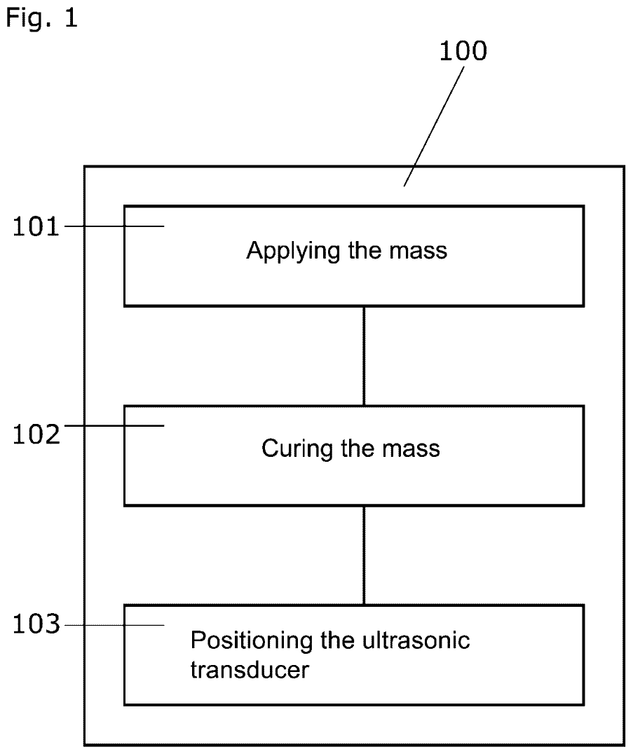

FIG. 1 describes a method according to the invention by way of example;

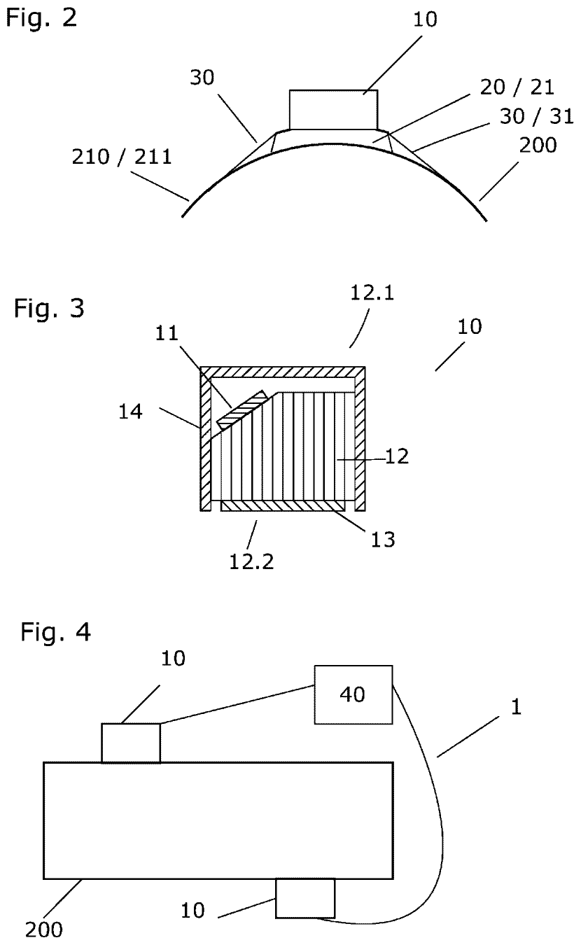

FIG. 2 shows a sketch of a section of a front view of a clamp-on ultrasonic transducer by way of example installed according to the invention;

FIG. 3 is a sketch of a cross-section of a schematic clamp-on ultrasonic transducer;

FIG. 4 is a sketch of a clamp-on ultrasonic measuring device by way of example.

In a method 100 according to the invention for installing a clamp-on ultrasonic measuring device 1 as outlined in FIG. 1, in a first method step 101 a flowable compound 21 is applied to an outer surface 211 of a wall 210 of a pipeline 200 with a rough surface, which compound forms a sealing layer 20.

In one embodiment, the flowable compound is a plastic, self-curing compound and comprises at least one of the following materials: silicone, acrylic, PU, adhesives such as one-or two-component adhesives, putty, epoxy, varnish, paint, concrete, mortar.

In one embodiment, the flowable compound is brought into a flowable state by heating, cures by cooling, and comprises at least one of the following materials: a solder, a glass, a hot-melt adhesive.

When it cures, for example by cooling or heating or waiting, the previously flowable compound assumes an elastic state, the sealing layer being adapted to the surface condition of the outer surface of the pipeline and sealing it. In this way, a long-term stable acoustic coupling between the pipeline and the clamp-on ultrasonic transducer can be ensured.

In one embodiment, a separating device 30 can be applied to the compound 21, which separating device is designed, for example, as a sheet or foil, a fabric or a disk. In this case, the separating device can have at least one of the following materials: a plastics material such as PET, PE, PVC, PS, PEI, PI, a metal such as aluminum or stainless steel, a ceramic or a glass.

After the compound 21 has cured, the separating device can be removed so that the ultrasonic transducer can make direct mechanical contact with the sealing layer without the risk of sticking. This can be advantageous, for example, in the case of sealing layers that are soft and elastic after curing, such as silicone. However, after the compound has cured, the separating device can also be retained. This can be advantageous for hard, elastic sealing layers such as concrete. In this case, a disk-shaped separating device made of metal, ceramic or glass can be advantageous. By means of the separating device, the geometric shape of a plastic, self-curing compound can be influenced during or after curing, or the clamp-on ultrasonic transducer can be prevented from sticking to the compound. For example, in the case of materials that are liquid before curing, such as solder, surface roughness caused by curing can be rendered harmless.

In a third method step during or after curing, one of at least one clamp-on ultrasonic transducers 10 of the clamp-on ultrasonic measuring device 1 is positioned on the separating device or the sealing layer.

In this way, a robust and long-term stable method for installing a clamp-on ultrasonic measuring device can be implemented.

FIG. 2 shows a sketch of a section of a front view of a clamp-on ultrasonic transducer by way of example, configured according to the invention, a sealing layer 20 having a compound 21 being applied to a pipeline 200 with a wall 210 and an outer surface of the wall 211, the compound being cured according to the invention. With curing, a clamp-on ultrasonic transducer 10 is positioned on the sealing layer, it being possible for a separating device 30 to be arranged between the sealing layer and the ultrasonic transducer, as shown here. Alternatively, however, the separating device can be omitted or can be removed before positioning the clamp-on ultrasonic transducer. The separating device can, for example, form a convex envelope on a side of the sealing layer facing away from the pipeline and can encompass the sealing layer, leaving a side facing the pipeline free. The separating device can have a coating 31, which coating has a self-adhesive, adhesion-enhancing or adhesion-reducing effect. The adhesive properties of the coating can thus be adapted to the sealing layer and/or to the clamp-on ultrasonic transducer.

FIG. 3 is a sketch of a section through a clamp-on ultrasonic transducer 10 by way of example, which has a transducer element 11, a coupling body 12 and a base 13. The transducer element 11 is arranged on a first side 12.1 of the coupling body facing away from the pipeline. The base 13 is arranged on a second side 12.2 of the coupling body facing the pipeline. Ultrasonic signals can be generated and received by the transducer element. Clamp-on ultrasonic transducers usually also have a housing 14, which guides and positions the coupling element and, if necessary, forms the separating device in portions. Clamp-on ultrasonic transducers are usually pressed against the outer surface of the pipeline, for example by means of a screw connection or a spring device.

FIG. 4 is a sketch of a clamp-on ultrasonic measuring device 1 by way of example, with two ultrasonic transducers 10 offset along a pipeline axis and an electronic measuring/operating circuit 40 which is designed to operate the clamp-on ultrasonic transducers, evaluate measurement signals of the clamp-on ultrasonic transducers, and provide measured values of a measured variable.

The clamp-on ultrasonic measuring device shown here can, for example, be an ultrasonic flowmeter based on the transit time or transit time difference principle.

Alternatively, the invention can also be applied to clamp-on ultrasonic measuring devices based on the Doppler principle. In this case, a person skilled in the art is not limited to measuring a flow rate, but rather can also apply the invention, for example, to fill level measurements or the like.

### List of reference signs

1 clamp-on ultrasonic flowmeter
10 clamp-on ultrasonic transducer
11 transducer element
12 coupling body
12.1 first side
12.2 second side
13 base
14 housing
20 sealing layer
21 compound
30 separating device
31 coating
40 electronic measuring/operating circuit
100 method
101 first method step
102 second method step
103 third method step
200 pipeline
210 wall
211 outer surface

1-14. (canceled)

15. A method for installing a clamp-on ultrasonic measuring device on a pipeline in order to measure a media property of a medium flowing through the pipeline, wherein the clamp-on ultrasonic measuring device has at least one clamp-on ultrasonic transducer,
wherein the pipeline has a wall with an outer surface,
wherein in a first method step, a sealing layer comprising a flowable compound is applied onto a portion of the outer surface,
wherein in a second method step, the sealing layer cures or is caused to cure,
wherein in a third method step during or after the curing, one of the at least one clamp-on ultrasonic transducers is positioned.

16. The method according to claim 15,
wherein the flowable mass is a plastic, self-curing mass and comprises at least one of the following materials:
silicone, acrylic, PU, adhesives such as one-or two-component adhesives, putty, epoxy, varnish, paint, concrete, mortar.

17. The method according to claim 15,
wherein the flowable mass is brought into a flowable state by heating and cures by cooling and comprises at least one of the following materials:
a solder, a glass, a hot melt adhesive, a metal, wax or bitumen.

18. The method according to claim 15,
where the curing is controlled by electromagnetic radiation such as UV, infrared or microwave.

19. The method according to claim 15,
wherein the sealing layer is applied by additive manufacturing such as deposition welding, sintering such as laser sintering, or vulcanization.

20. The method according to claim 15,
wherein a separating device is installed between the clamp-on ultrasonic transducer and the compound.

21. The method according to claim 20,
wherein the separating device has a sheet or a film or a fabric and has a thickness of at most 10 millimeters, and in particular at most 3 millimeters and preferably at most 1 millimeter.

22. The method according to claim 15,
wherein the separating device is disc-shaped and in particular is matched to geometric dimensions of the clamp-on ultrasonic transducer.

23. The method according to claim 15,
wherein the separating device has at least one of the following materials:
a plastics material such as PET, PE, PVC, PS, PEI, PI, a metal such as aluminum or stainless steel, a ceramic or a glass.

24. The method according to claim 15,
wherein the separating device has a coating on at least one side, which coating is self-adhesive, adhesion-enhancing or adhesion-reducing.

25. The method according to claim 15,
wherein the separating device has or forms a volume in which the curable compound is arranged.

26. The method according to claim 15,
wherein the clamp-on ultrasonic transducer has the following:
a transducer element;
a coupling body with a first side facing away from the pipeline and a second side facing the pipeline,
wherein the transducer element is arranged on the first side,
a base which is arranged on the second side of the coupling body, wherein the base is made of a plastics or elastic material such as silicone or acrylic,
wherein when positioning the clamp-on ultrasonic transducer, the base forms the acoustic and mechanical contact with the separating device or the sealing layer.

27. The method according to claim 26,
wherein a side of the separating device facing the pipeline is geometrically adapted to the outer surface of the pipeline, and/or the side facing the clamp-on ultrasonic transducer is geometrically adapted to the clamp-on ultrasonic transducer.

28. A clamp-on ultrasonic measuring device configured to implement a method, comprising:
at least one clamp-on ultrasonic transducer with a transducer element,
a coupling body with a first side facing away from the pipeline and a second side facing the pipeline, wherein the transducer element is arranged on the first side,
a base which is arranged on the second side of the coupling body, wherein when the clamp-on ultrasonic transducer is positioned, the base forms the acoustic and mechanical contact with the sealing layer;
an electronic measuring/operating circuit which is configured to operate the at least one clamp-on ultrasonic transducer, to evaluate measurement signals of the at least one clamp-on ultrasonic transducer, and to provide measured values of a measured variable;
wherein the pipeline has a wall with an outer surface,
wherein in a first method step, a sealing layer comprising a flowable compound is applied onto a portion of the outer surface,
wherein in a second method step, the sealing layer cures or is caused to cure,
wherein in a third method step during or after the curing, one of the at least one clamp-on ultrasonic transducers is positioned.
